(19) United States
(12) Patent Application Publication
(10) Pub. No.: US 2008/0046934 A1
(43) Pub. Date: Feb. 21, 2008

(54) Apparatus for providing over-the-air (OTA) information using text message and method thereof

(75) Inventor: Chea-il Lim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/638,577

(22) Filed: Dec. 14, 2006

(30) Foreign Application Priority Data
Jul. 25, 2006 (KR) 10-2006-0069473

(51) Int. Cl. H04N 7/20; G06F 3/00; G06F 13/00; H04N 7/16; H04N 5/445

(52) U.S. Cl. 725/73; 725/136; 725/135; 725/38

(57) ABSTRACT

An apparatus for providing information about over-the-air (OTA) transmission is provided, which includes a communication interface connected with an external device for communication via an external communication network; and a controlling part which controls the communication interface such that the information about OTA transmission is transmitted to the external device via the external communication network. As a result, OTA information can be provided to the users more efficiently, by transmitting text message regarding the OTA information to the external devices of the users.

### CROSS-REFERENCE TO RELATED APPLICATION

This application claims priority under 35 U.S.C. §119(a) of Korean Patent Application No. 10-2006-0069473, filed Jul. 25, 2006, in the Korean Intellectual Property Office, the entire contents of which are incorporated herein by reference.

### GROUND OF THE INVENTION

1. Field of the Invention

Apparatuses and methods consistent with the present invention relate to providing information about over-the-air (OTA) transmission. More particularly, apparatuses and methods consistent with the present invention relate to informing users about OTA transmission using text messages.

2. Description of the Related Art

A broadcast receiver tunes in to a desired channel and receives broadcast signal through the channel, and processes the received signal so that the corresponding content can be output through a display and speaker. TVs, settop boxes, or settop box-integrated TVs are the representative examples of such broadcast receiver. As the broadcast reception has been enabled via the mobile terminals, the mobile terminals may also belong to the broadcast receiver.

The recent change of analog broadcasting reception to a digital system has caused increase of software size, and problematically, increase of software bugs. In order to save cost of providing software, many manufacturers of the broadcast receivers use over-the-air (OTA) software downloads. Therefore, many download applications, services, or software by OTA.

The OTA downloading requires the broadcast receiver to be tuned in to a designated channel while the intended software is transmitted through the broadcast signal. The broadcast receiver fails to receive the software if it is not tuned in to the designated channel during the time that the software is transmitted through the broadcast signal. In order to prevent this transmission failure, it is necessary that the users know the time and the channel that the software is transmitted through the broadcast signal. The OTA will be useless if the broadcast receiver is not tuned in to the designated channel.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

Aspects of the present invention provide an apparatus for providing information about over-the-air (OTA) transmission efficiently, by sending text messages to an external device and informing about the OTA transmission.

The present invention provides an apparatus for providing information about over-the-air (OTA) transmission, comprising: a communication interface connected with an external device for communication via an external communication network; and a controlling part which controls the communication interface such that the information about OTA transmission is transmitted to the external device via the external communication network.

The controlling part controls the communication interface such that a message regarding the information about the OTA transmission is written and transmitted to the external device according to contact information of the external device, when the information indicative of OTA transmission is received.

A display part may be further provided, which indicates a list of contact information of the external device, through which the contact information is added, changed or deleted.

The contact information of the external device may comprise at least one of a portable terminal number, a mobile phone number, a telephone number, a cellular phone number, and an email address.

The information indicative of OTA transmission may comprise at least one of a channel to download a software, a date to download the software, a time to download the software, and a model name of a broadcast receiver to use the software.

The external device may comprise at least one of a portable terminal, a mobile phone, a telephone, a cellular phone, and a personal computer (PC).

The external communication network may comprise at least one of a public switched telephone network (PSTN), an internet, a local area network (LAN), and a wireless network.

The present invention also provides a method of providing information about over-the-air (OTA) transmission, comprising: determining whether the information indicative of OTA transmission is included in a received broadcast signal; and transmitting a text message regarding the information about OTA transmission to an external device via an external communication network, when determining that the information about OTA transmission is included.

The transmitting operation may comprise transmitting a text message about the information about OTA transmission to the external device according to contact information of the external device.

Displaying a list of contact information of the external device may be further provided, through which the contact information of the external device is added, changed or deleted.

The contact information of the external device may comprise at least one of a portable terminal number, a mobile phone number, a telephone number, a cellular phone number, and an email address.

The information about OTA transmission may comprise at least one of a channel to download a software, a date to download the software, a time to download the software, and a model name of a broadcast receiver to use the software.

The external device may comprise at least one of a portable terminal, a mobile phone, a telephone, a cellular phone, and a personal computer (PC).

The external communication network may comprise at least one of a public switched telephone network (PSTN), an internet, a local area network (LAN), and a wireless network.

### BRIEF DESCRIPTION OF THE DRAWINGS

The above aspects and other features of the present invention will become more apparent by describing in detail exemplary embodiments thereof with reference to the attached drawings, in which:

FIG. 1 illustrates the process in which the information about over-the-air (OTA) transmission is transmitted to a user according to an exemplary embodiment of the present invention;

FIG. 2 is a block diagram of a broadcast receiver providing a user with information about OTA transmission according to an exemplary embodiment of the present invention;

FIG. 3 is a flowchart illustrating a method of storing contact numbers of a user intending to receive information about OTA transmission;

FIG. 4 illustrates an example of a contact list to send the information about OTA transmission; and

FIG. 5 is a flowchart illustrating a method of sending text message about OTA transmission to an external device.

### DESCRIPTION OF THE EXEMPLARY EMBODIMENTS

Hereinafter, aspects of the present invention will be described in detail with reference to the drawings.

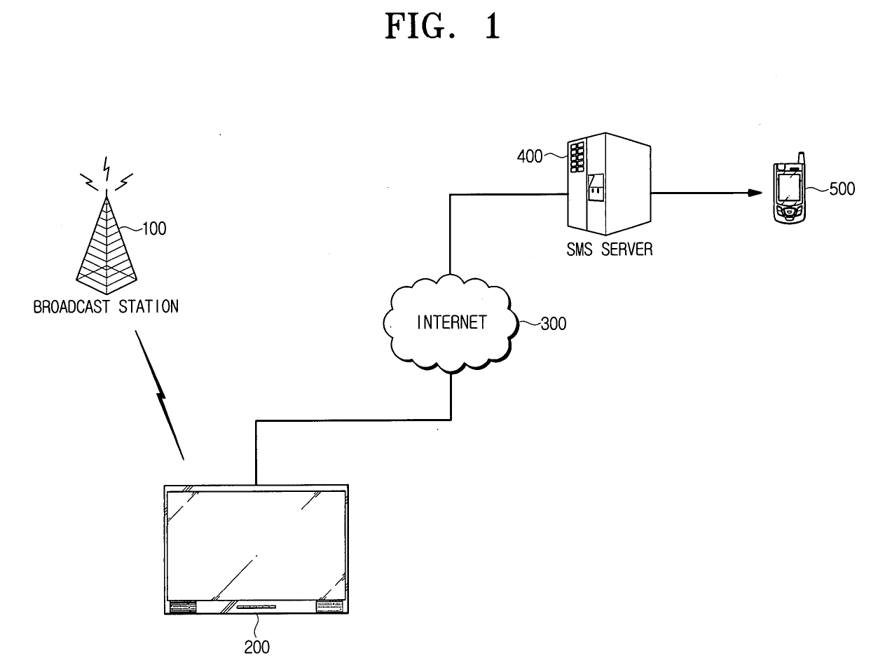

FIG. 1 schematically illustrates the process in which the information about over-the-air (OTA) transmission (hereinafter called ‘OTA information’) is provided to a user according an exemplary embodiment of the present invention. Referring to FIG. 1, a broadcast station 100, a broadcast receiver 200, an internet 300, a short message service (SMS) server 400 and a mobile phone 500, are necessary to send the text message regarding OTA information.

The broadcast station 100 transmits, over the air, a broadcast signal containing the OTA information. Accordingly, the broadcast receiver 200 receives the broadcast signal, divides the signal into audio signal, video signal and other broadcast information signal, and determines whether there is OTA information in the divided signal. If there is OTA information, the broadcast receiver 200 writes a message regarding the OTA information (hereinafter called ‘OTA text message’) based on the OTA information, and causes the OTA text message to be transmitted to an external device via the internet 300 and the SMS server 400.

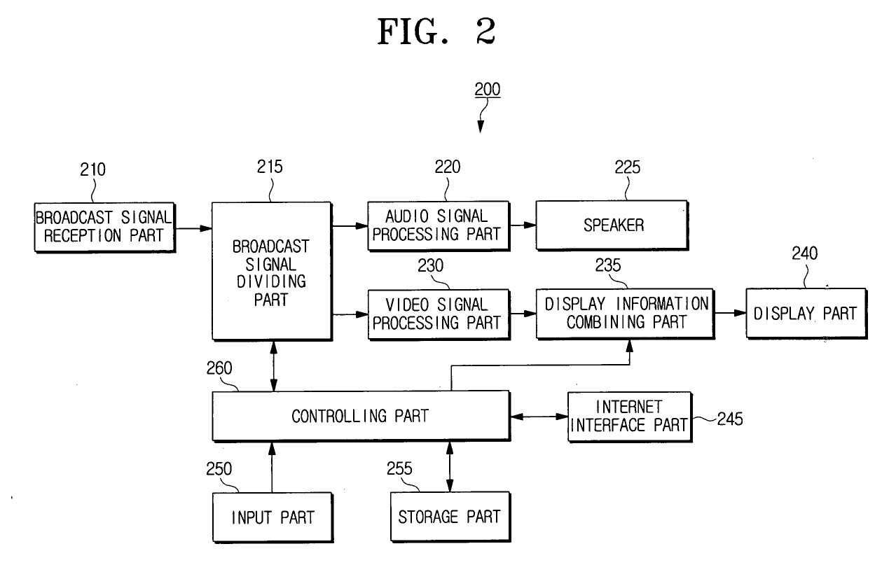

FIG. 2 is a block diagram of the broadcast receiver device 200 transmitting the OTA information. Referring to FIG. 2, the broadcast receiver 200 may include a broadcast signal reception part 210, a broadcast signal dividing part 215, an audio signal processing part 220, a video signal processing part 225, a display part 240, an internet interface part 245, an input part 250, a storage part 255 and a controlling part 260.

The broadcast signal reception part 210 is tuned in to one of available broadcast signals through cable or antenna, either in wired way or wirelessly. The broadcast signal reception part 210 demodulates the tuned broadcast signal.

The broadcast signal dividing part 215 divides the broadcast signal output from the broadcast signal reception part 210 into audio signal, video signal and broadcast information signal. After being divided at the broadcast signal dividing part 215, the audio signal is provided to the audio signal processing part 220, the video signal is provided to the video signal processing part 230, and the broadcast information is provided to the controlling part 260, respectively.

The audio signal processor 220, upon receiving the audio signal from the broadcast signal dividing part 215, de-compresses the audio signal, converts the audio signal into analog signal and then outputs to the speaker 225.

The video signal also de-compresses the video signal received from the broadcast signal dividing part 215, processes the video signal and outputs to the display part 240 which will be described below.

A display information combining part 235 is also provided, which operates such that display information is provided through a predetermined location of a display screen. The display information combining part 235 may indicate a list of contacts of external devices which will receive OTA information in the on-screen display (OSD), or graphic user interface (GUI) ways.

The display part 240 displays the video signal output from the video signal processing part 230 and the display information according to the control of the controlling part 260.

The internet interface part 245 enables communication of text message, which is written at the controlling part 260 regarding the OTA information, with the external devices through the internet 300 and the SMS server 400 (hereinafter collectively called ‘external communication network’).

The input part 250 receives a user command and transmits it to the controlling part 260, and is usually provided at a front part of the broadcast receiver device 200. The input part 250 may also include a remote controller to receive user command therethrough, and a light receiving part which receives signal from the remote controller and sends it to the controlling part 260.

The input part 250 may include a contact list button with which a contact information of an intended external device to receive OTA text message, is selected, and numeric, alphabetic, or symbol buttons to input or change the contact information of the external device.

The input part 250 may be constructed to provide a menu items corresponding to the buttons.

The storage part 255 stores a driving program to activate the broadcast receiver 200, and also broadcast information, particularly, the OTA information, output from the broadcast signal dividing part 215. Additionally, the storage part 255 may store information about the contact list which is input by the user.

The controlling part 260 controls the broadcast signal reception part 210, the audio signal processing part 220 and the video signal processing part 230 according to the user command input through the input part 250.

The controlling part 260 determines whether the broadcast information output from the broadcast signal dividing part 215 includes OTA information. The controlling part 260 may also control the storage part 255 to store the contact information input through the input part 250, or the OTA information therein.

The controlling part 260 writes a text message based on the OTA information when determining that the OTA information is included in the broadcast information received at the broadcast receiver 200, reads out the contact information of the external device of the user from the contact list previously stored in the storage part 255, and controls the internet interface part 245 such that the text message about the OTA information is transmitted to the external device through the external communication network.

The control part 260 may also control the display information combining part 235 and the display part 240 to display input contact information to let the user know that the contact information he intends to input matches the displayed contact information.

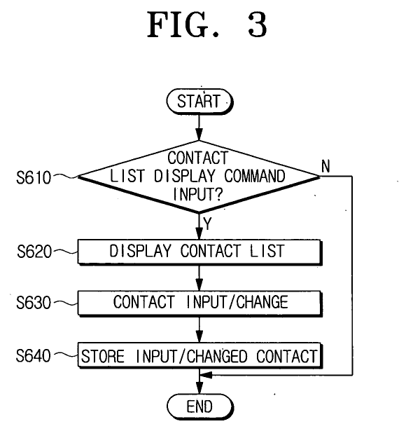

The operation of the controlling part 260 to store contact information will be explained in detail below with reference to FIG. 3.

FIG. 3 is a flowchart illustrating a method of storing the contact information of the devices intending to receive the OTA information, according to an exemplary embodiment of the present invention.

The controlling part 260 determines if a contact list display command is input or not (S610). That is, the controlling part 260 determines that the contact list display command is input, when the user inputs a command through the contact list button provided at the input part 250, requesting that the contact list is displayed through the display part 240. Alternatively, the controlling part 260 may determine that the contact list display command is input, when the user selects a contact list item from the menu items.

When the contact list display command is input (S610-Y), the controlling part 260 searches the contact list stored in the storage part 255 and controls the display part 240 to display the searched contact list (S620).

The user inputs or changes the contact list through the input part 250. That is, the user inputs or changes the contact information of the device intending to receive the text message about the OTA information (S630). More specifically, the user may input his mobile phone 500 number through the numeric or symbol buttons of the input part 250, and the controlling part 260 may control the display part 240 to display as the user commands. Accordingly, the user knows that the contact information is correctly input.

The controlling part 260 stores the contact list in the storage part 255 (S640).

Although FIG. 3 shows the example where the controlling part 260 stores the user's mobile phone 500 number in the storage part 255, one will understand that other types of communication tools can also be employed if they can receive text message about OTA information. For example, the contact information may include the portable terminal numbers, telephone numbers, cellular phone numbers or email addresses.

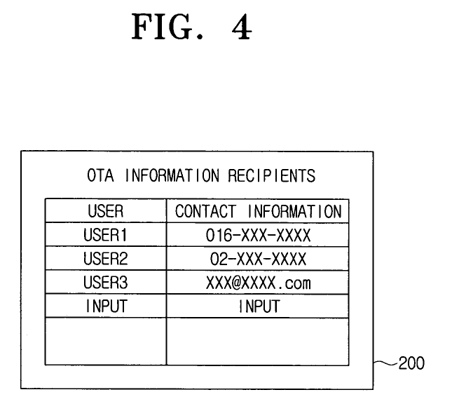

FIG. 4 illustrates an example of a contact list to receive OTA information. The list of contacts to receive the text message about OTA information (hereinafter, ‘OTA information recipients’) is shown at the top. There are names of the users in the left column of the table, while there are contact information of the external devices in the right column, such as mobile phone 500 numbers, telephone numbers, or email addresses. The user may add or change the user names or the OTA information recipients.

The process of the controlling part 260 storing the OTA information recipients and displaying contact list, has been explained above with reference to FIGS. 3 and 4. The method of transmitting the OTA information to the external devices will now be explained below.

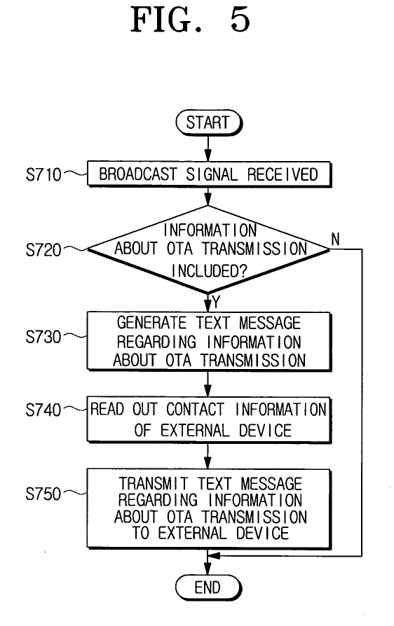

FIG. 5 is a flowchart illustrating a method of transmitting OTA information to an external device corresponding to the contact information.

The broadcast signal reception part 210 receives a broadcast signal (S710). That is, the broadcast signal reception part 210 tunes in to one of available broadcast signals through a cable or an antenna, and demodulates the incoming broadcast signal.

The controlling part 260 determines whether the received broadcast signal includes OTA information (S720). That is, the broadcast signal dividing part 215 divides the broadcast signal of the broadcast signal reception part 210 into audio signal, video signal and broadcast information signal. Among the dividing signals, the controlling part 260 determines whether the broadcast information includes the OTA information.

The broadcast station 100 transmits the OTA information over-the-air prior to transmitting the software for download. The OTA information may include the date and time of transmitting the software, the channel for the software, or the model name of the broadcast receiver 200 using the software. The controlling part 260 accordingly determines whether the above types of OTA information are included in the broadcast information signal.

When determining that the OTA information is included (S720-Y), the controlling part 260 accordingly generates a text message regarding the OTA information (S730). The text OTA information may include the date and time, and the channel of transmitting the OTA software for download, or the model name of the broadcast receiver 200 using the software for download.

The controlling part 260 reads out the contact information from the contact list of the storage part 255 (S740). When the OTA information is included in the broadcast information signal, the controlling part 260 reads out the contact information from the contact list which is previously stored in the storage part 255 (FIG. 3). The contact information usually include numeric information such as mobile phone numbers, but may also include English alphabets as in email addresses.

The controlling part 260 controls the internet interface part 245 connected with the internet 300 such that the text message about the OTA information is transmitted to the external device corresponding to the contact information (S750).

The message about the OTA information and the contact information may be transmitted through the internet interface part 245 and the internet 300 to the SMS server 400. The SMS server 400 generates a text message based on the received message, and transmits the generated text message to the intended device for the notice of the user. As a result, the user knows the date and time, and the channel of transmitting the OTA software for download, and the types of broadcast receiver to download the software, and the broadcast receiver 200 can carry out upgrade on the intended time.

In the exemplary embodiments explained above, the internet and the SMS server are used as the examples of external communication networks (FIGS. 1 and 3). However, other types of networks communication networks can be used, if the networks can connect the external devices such as portable terminals, mobile phones 500, telephones, cellular phones and PCs which receive text messages. For example, public switched telephone network (PSTN), local area network (LAN) or wireless network may be adopted. Because the process of transmitting text messages over the external communication networks is generally known in the art, this will not be explained in detail for the sake of brevity.

In operations S730 and S740, the controlling part 260 writes a text message about OTA information when the OTA information is included in the broadcast information signal, and reads out contact information from the contact list previously stored in the storage part 255. However, this series of operations may be reversed. For example, the controlling part 260 may read out contact information from the storage part 255 when the OTA information is included in the broadcast information signal, and the write a text message regarding the OTA information.

Furthermore, in the above exemplary embodiments, the OTA information is transmitted to the broadcast receiver 200 and the broadcast receiver 200 stores contact information of the external devices to receive text messages about the OTA information. However, this should not be construed as limiting.

The broadcast receiver 200 itself may generate text message regarding the OTA information and send the text message to the external device, when determining that the broadcast signal includes the OTA information. Alternatively, the broadcast station 100 may have a device to directly send text message about OTA information to the external device at the contact information. Accordingly, the broadcast receiver 200 is only one example of providing text message regarding the OTA information, and one will understand that the present invention can be applied to any apparatus and method which provides external devices with text message regarding the OTA information either directly, or indirectly.

As explained above, according to exemplary embodiments of the present invention, OTA information can be provided to the users more efficiently, by transmitting text message regarding the OTA information to the external devices of the users.

The above description is illustrative and not restrictive. Many variations of the invention will become apparent to those of skill in the art upon review of this disclosure. The scope of the invention should, therefore, not be determined by the above descriptions, but instead should be determined by the appended claims along with their full scope of equivalents.

What is claimed is:

1. An apparatus for providing information about over-the-air (OTA) transmission, comprising:
a communication interface connected with an external device for communication via an external communication network; and
a controlling part which controls the communication interface such that the information about OTA transmission is transmitted to the external device via the external communication network.

2. A broadcast receiver, comprising:
a communication interface connected with an external device for communication via an external communication network; and
a controlling part which controls the communication interface such that information about over-the-air (OTA) transmission is transmitted to the external device via the external communication network.

3. The broadcast receiver of claim 2, wherein the controlling part controls the communication interface such that a message regarding the information about the OTA transmission is written and transmitted to the external device according to contact information of the external device, when the information indicative of OTA transmission is received.

4. The broadcast receiver of claim 3, further comprising a display part which indicates a list of contact information of the external device, through which the contact information is added, changed or deleted.

5. The broadcast receiver of claim 3, wherein the contact information of the external device comprises at least one of a portable terminal number, a mobile phone number, a telephone number, a cellular phone number, and an email address.

6. The broadcast receiver of claim 2, wherein the information indicative of OTA transmission comprises at least one of a channel to download a software, a date to download the software, a time to download the software, and a model name of a broadcast receiver to use the software.

7. The broadcast receiver of claim 2, wherein the external device comprises at least one of a portable terminal, a mobile phone, a telephone, a cellular phone, and a personal computer (PC).

8. The broadcast receiver of claim 2, wherein the external communication network comprises at least one of a public switched telephone network (PSTN), an internet, a local area network (LAN), and a wireless network.

9. A method of providing information about over-the-air (OTA) transmission, comprising:
determining whether the information indicative of OTA transmission is included in a received broadcast signal; and
transmitting a text message regarding the information about OTA transmission to an external device via an external communication network, when determining that the information about OTA transmission is included.

10. The method of claim 9, wherein the transmitting comprises transmitting a text message about the information about OTA transmission to the external device according to contact information of the external device.

11. The method of claim 10, further comprising displaying a list of contact information of the external device, through which the contact information of the external device is added, changed or deleted.

12. The method of claim 10, wherein the contact information of the external device comprises at least one of a portable terminal number, a mobile phone number, a telephone number, a cellular phone number, and an email address.

13. The method of claim 9, wherein the information about OTA transmission comprises at least one of a channel to download a software, a date to download the software, a time to download the software, and a model name of a broadcast receiver to use the software.

14. The method of claim 9, wherein the external device comprises at least one of a portable terminal, a mobile phone, a telephone, a cellular phone, and a personal computer (PC).

15. The method of claim 9, wherein the external communication network comprises at least one of a public switched telephone network (PSTN), an internet, a local area network (LAN), and a wireless network.
